(19) United States
(12) Patent Application Publication
(10) Pub. No.: US 2014/0184962 A1
(43) Pub. Date: Jul. 3, 2014

(54) STEREOSCOPIC DISPLAY DEVICE

(71) Applicants: Takehiro Murao, Osaka-shi (JP); Takuto Yoshino, Osaka-shi (JP); Hiroshi Fukushima, Osaka-shi (JP); Tomoo Takatani, Osaka-shi (JP)

(72) Inventors: Takehiro Murao, Osaka-shi (JP); Takuto Yoshino, Osaka-shi (JP); Hiroshi Fukushima, Osaka-shi (JP); Tomoo Takatani, Osaka-shi (JP)

(73) Assignee: SHARP KABUSHIKI KAISHA, Osaka-shi, Osaka (JP)

(21) Appl. No.: 14/237,597

(22) PCT Filed: Jul. 31, 2012
(86) PCT No.: PCT/JP2012/069486

§ 371 Date: Feb. 7, 2014

(30) Foreign Application Priority Data
Aug. 9, 2011 (JP) 2011-174308

(51) Int. Cl. G02B 27/22

(52) U.S. Cl. CPC G02B 27/2214
USPC 349/15

(57) ABSTRACT

The purpose of the present invention is to provide a vertically and horizontally positionable stereoscopic display device that can obtain an excellent stereoscopic display by reducing light leakage through areas (inter-line areas) between drive electrodes (36, 42) and auxiliary electrodes (38, 44) and improving light shielding properties of light shielding parts. A switching liquid crystal panel (14) provided in the stereoscopic display device of the present invention realizes a parallax barrier (48) in which transmission parts (52) and light shielding parts (50) are arrayed alternately. The switching liquid crystal panel (14) includes a pair of substrates (30, 32) on which drive electrodes (36, 42) and auxiliary electrodes (38, 44) are arranged alternately. When the switching liquid crystal panel (14) is viewed from the front, the drive electrodes (36) and the auxiliary electrodes (38) formed on the substrate (30) are orthogonal to the drive electrodes (42) and the auxiliary electrodes (44) formed on the substrate (32). A liquid crystal layer (34) has a retardation that is set at a first minimum, and a dielectric anisotropy of 4 or greater.

### TECHNICAL FIELD

The present invention relates to a stereoscopic display device that includes a switching liquid crystal panel.

### BACKGROUND ART

Conventionally, the parallax barrier method has been known as a method of showing stereoscopic images to a viewer, without use of special glasses. Among examples of the stereoscopic display device of the parallax barrier type, for example, the following configuration is available, as disclosed in JP2006-119634A: even in the case where the pattern in the screen section where images are provided is changed as required, three-dimensional video images are provided according to the screen section pattern thus changed.

The stereoscopic video display device disclosed in the foregoing publication includes an optical controller that selectively transmits/blocks light fed from a light source. The optical controller includes a first substrate, a second substrate, and liquid crystal arranged between these substrates. On the first substrate, first electrodes and second electrodes are formed, which are alternately arranged in a first direction. On the second substrate, third electrodes and fourth electrodes are formed, which are alternately arranged in a second direction that is vertical to the first direction. In the stereoscopic video display device disclosed in the foregoing publication, in the case where the screen section is arranged in the portrait state, i.e., arranged so as to be long in the vertical direction, a parallax barrier in which light shielding parts and light transmission parts are arranged alternately is realized by applying a data voltage across any of the third electrodes and the fourth electrodes when a reference voltage is applied to the first electrodes and the second electrodes. In the case where the screen section is arranged in the landscape state, i.e., arranged so as to be long in the horizontal direction, a parallax barrier in which the light shielding parts and the light transmission parts are arranged alternately is realized by applying data voltage to any of the first electrodes and the second electrodes when a reference voltage is applied to the third electrodes and the fourth electrodes.

### DISCLOSURE OF INVENTION

In the stereoscopic display device disclosed in the foregoing publication, a common electrode when a parallax barrier is realized is not a single electrode, but it is provided by a plurality of electrodes. In the plurality of electrodes, a clearance (hereinafter referred to as an inter-line area) for preventing leakage is formed between two adjacent electrodes. In this inter-line area, a satisfactory electric field cannot be provided, and liquid crystal does not respond. Therefore, light leakage occurs in the inter-line area, and this area does not become a satisfactory light shielding area. As a result, satisfactory image separation cannot be achieved, and excellent stereoscopic display cannot be obtained.

It is an object of the present invention to provide a stereoscopic display device that is capable of achieving excellent stereoscopic display by reducing light leakage in the interline areas and improving light shielding properties of the light shielding parts.

A stereoscopic display device of the present invention includes: a display panel that has a plurality of pixels, and displays a synthetic image in which a right eye image and a left eye image that are divided in a stripe form are arrayed alternately; and a switching liquid crystal panel that is arranged on one side in the thickness direction of the display panel and is capable of realizing a parallax barrier in which transmission parts that transmit light and light shielding parts that block light are arranged alternately. The switching liquid crystal panel includes: a pair of substrates; a liquid crystal layer sealed between the substrates in pair; a plurality of drive electrodes formed on each of the substrates in pair; and a plurality of auxiliary electrodes formed on each of the substrates in pair, the auxiliary electrodes and the drive electrodes being arranged alternately. In the stereoscopic display device, the drive electrodes and the auxiliary electrodes formed on one of the substrates in pair are orthogonal to the drive electrodes and the auxiliary electrodes formed on the other substrate when viewed from the front of the switching liquid crystal panel; a voltage different from a voltage applied to the drive electrodes and the auxiliary electrodes formed on the one substrate is applied to the drive electrodes formed on the other substrate, whereby the light shielding parts are formed; the liquid crystal layer has a retardation set at a first minimum; and the liquid crystal layer has a dielectric anisotropy of 4 or greater.

In the stereoscopic display device of the present invention, light leakage can be reduced in the inter-line areas between the electrodes. Therefore, excellent stereoscopic display can be achieved.

### BRIEF DESCRIPTION OF DRAWINGS

FIG. 1 shows an exemplary schematic configuration of a stereoscopic display device as an embodiment of the present invention.

FIG. 2 is a plan view showing pixels of a display panel.

FIG. 3 is a cross-sectional view showing an exemplary schematic configuration of a switching liquid crystal panel, which is a cross-sectional view taken along a line III-III in FIG. 4.

FIG. 4 is a cross-sectional view showing an exemplary schematic configuration of a switching liquid crystal panel, which is a cross-sectional view taken along a line IV-IV in FIG. 3.

FIG. 5 is a plan view that shows drive electrodes and auxiliary electrodes formed on one of substrates included in a switching liquid crystal panel, and a rubbing direction of an alignment film thereon.

FIG. 6 is a plan view that shows drive electrodes and auxiliary electrodes formed on the other substrate included in the switching liquid crystal panel, and a rubbing direction of an alignment film thereon.

FIG. 7 is a cross-sectional view showing a state in which a parallax barrier is provided in a switching liquid crystal panel, which is a cross-sectional view corresponding to the III-III cross section.

FIG. 8 is a cross-sectional view showing a state in which a parallax barrier is provided in a switching liquid crystal panel, which is a cross-sectional view corresponding to the IV-IV cross section.

FIG. 9 is a graph showing the relationship between brightness and an angle θ.

FIG. 10 is a graph showing the relationship between a crosstalk ratio and an angle θ.

FIG. 11 is a graph showing the relationship between a dielectric anisotropy Δε and a crosstalk ratio.

FIG. 12 is an explanatory view schematically showing a state of liquid crystal molecules positioned between drive electrodes and auxiliary electrodes in the case where the dielectric anisotropy Δε is smaller than 4 and light shielding parts are provided.

FIG. 13 is a model diagram showing the light shielding parts in the state shown in FIG. 12.

FIG. 14 is an explanatory view schematically showing a state of liquid crystal molecules positioned between the drive electrodes and the auxiliary electrodes, in the case where the dielectric anisotropy Δε is 4 or greater and the light shielding parts are provided.

FIG. 15 is a model diagram showing the light shielding part in the state shown in FIG. 14.

FIG. 16 is a graph showing the relationship between the angle of a rubbing axis with respect to a reference line and crosstalk, together with the relationship between the angle of a rubbing axis with respect to a reference line and barrier contrast.

### DESCRIPTION OF THE INVENTION

A stereoscopic display device according to one embodiment of the present invention includes: a display panel that has a plurality of pixels, and displays a synthetic image in which a right eye image and a left eye image that are divided in a stripe form are arrayed alternately; and a switching liquid crystal panel that is arranged on one side in the thickness direction of the display panel and is capable of realizing a parallax barrier in which transmission parts that transmit light and light shielding parts that block light are arranged alternately. The switching liquid crystal panel includes: a pair of substrates; a liquid crystal layer sealed between the substrates in pair; a plurality of drive electrodes formed on each of the substrates in pair; and a plurality of auxiliary electrodes formed on each of the substrates in pair, the auxiliary electrodes and the drive electrodes being arranged alternately. In the stereoscopic display device, the drive electrodes and the auxiliary electrodes formed on one of the substrates in pair are orthogonal to the drive electrodes and the auxiliary electrodes formed on the other substrate when viewed from the front of the switching liquid crystal panel; a voltage different from a voltage applied to the drive electrodes and the auxiliary electrodes formed on the one substrate is applied to the drive electrodes formed on the other substrate, whereby the light shielding parts are formed; the liquid crystal layer has a retardation set at a first minimum; and the liquid crystal layer has a dielectric anisotropy of 4 or greater (the first configuration).

In the first configuration, the retardation of the liquid crystal layer is set at a first minimum, and the dielectric anisotropy of the liquid crystal layer is 4 or greater. This allows the liquid crystal molecules to easily respond, even in parts in the liquid crystal layer corresponding to clearances (inter-line areas) between the drive electrodes and the auxiliary electrodes formed on one of a pair of substrates. This results in the reduction of light leakage in the light shielding parts.

The second configuration is the first configuration modified so that each of the substrates in pair includes an alignment film, and an angle formed between an alignment axis of the alignment film and a reference line that extends in a lengthwise direction of the drive electrodes is 35° or greater. In such a configuration, rubbing is unsatisfactory at boundaries between areas where the electrodes (drive electrodes or auxiliary electrodes) are formed and areas (step parts) where they are not formed. In the areas where the rubbing is unsatisfactory, the liquid crystal molecules are unstable, and easily respond even if the electric field is low. As a result, the light shielding properties in the inter-line areas are improved, whereby crosstalk is suppressed.

Hereinafter, more specific embodiments of the present invention are explained with reference to the drawings. It should be noted that, for convenience of explanation, each figure referred to hereinafter shows only principal members necessary for explanation of the present invention, in a simplified state, among the constituent members of the embodiments of the present invention. Therefore, the stereoscopic display device according to the present invention may include arbitrary constituent members that are not shown in the drawings referred to in the present specification. Further, the dimensions of the members shown in the drawings do not faithfully reflect actual dimensions of the constituent members, dimensional ratios of the constituent members, etc.

### EMBODIMENT

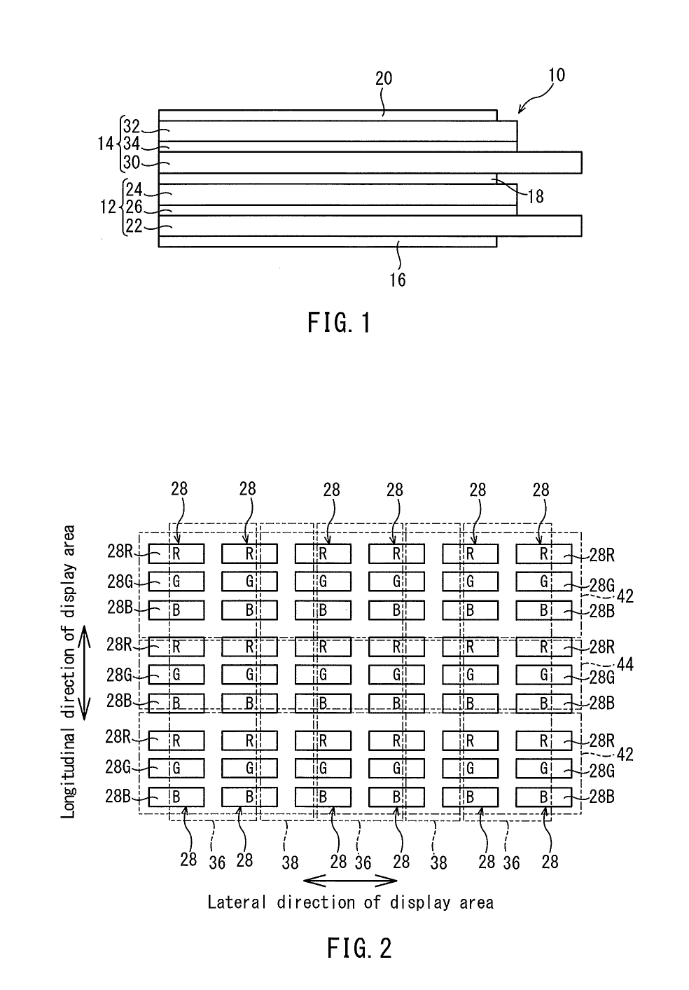

FIG. 1 shows a stereoscopic display device 10 as an embodiment of the present invention. The stereoscopic display device 10 includes a display panel 12, a switching liquid crystal panel 14, and polarizing plates 16, 18, and 20.

The display panel 12 is a liquid crystal panel. The display panel 12 includes an active matrix substrate 22, a counter substrate 24, and a liquid crystal layer 26 sealed between these substrates 22 and 24. In the display panel 12, the liquid crystal is in an arbitrary operation mode.

The display panel 12 includes a plurality of pixels 28, as shown in FIG. 2. The plurality of pixels 28 are formed, for example, in matrix form. The area where the plurality of pixels 28 are formed is a display area of the display panel 12.

Each pixel 28 may include a plurality of subpixels 28R, 28G, 28B, as shown in FIG. 2. In the example shown in FIG. 2, the plurality of subpixels 28R, 28G, 28B are arrayed in the longitudinal direction of the display area of the display panel 12. It should be noted that in the example shown in FIG. 2, the longitudinal direction of the display area refers to the vertical direction of the display area in the landscape display (the length in the horizontal direction is greater than the length in the vertical direction).

In the display panel 12, rows of pixels 28 that display images viewed by the right eye of a viewer (right eye images), and rows of pixels 28 that display images viewed by the left eye of the viewer (left eye images) are alternately arranged in the lateral direction and in the longitudinal direction of the display panel 12. In other words, the stereoscopic display device 10 is a stereoscopic display device that is suitable for the vertical and horizontal positioning (capable of performing the landscape display and the portrait display). With such a pixel arrangement, each of a right eye image and a left eye image is divided into pixel rows (into a stripe form), in both of the cases of the vertical positioning and the horizontal positioning. A synthetic image obtained by alternately arraying the portions of the right eye image and the portions of the left eye image thus obtained by dividing into a stripe form each is displayed in the display area of the display panel 12, in both of the cases of the vertical positioning and the horizontal positioning.

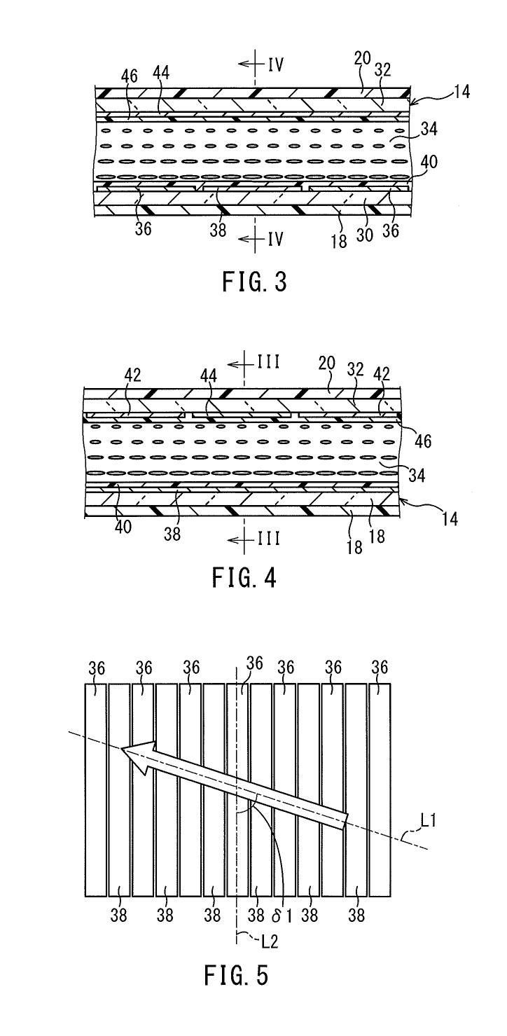

On the display panel 12, on one side thereof in the thickness direction, a switching liquid crystal panel 14 is arranged. As shown in FIG. 3 and FIG. 4, the switching liquid crystal panel 14 includes a pair of substrates 30, 32 and a liquid crystal layer 34.

The substrate 30, one of the pair, is, for example, a low-alkali glass substrate. On the substrate 30, drive electrodes 36 and auxiliary electrodes 38 are arrayed alternately, as shown in FIG. 5. Each of the electrodes 36 and 38 is, for example, a transparent conductive film such as an indium tin oxide film (ITO film).

The drive electrodes 36 and the auxiliary electrodes 38 extend in the longitudinal direction of the substrate 30 (in the longitudinal direction of the display area of the display panel 12), in an approximately uniform width each. In other words, the drive electrodes 36 and the auxiliary electrodes 38 are arrayed alternately in the lateral direction of the substrate 30 (in the lateral direction of the display area of the display panel 12).

The drive electrodes 36 and the auxiliary electrodes 38 are covered with an alignment film 40. The alignment film 40 is, for example, a polyimide resin film. As shown in FIG. 5, an angle δ1 formed between a rubbing axis L1 of the alignment film 40 and a reference line L2, which extends in the longitudinal direction of the substrate 30 is set in, for example, a range of 35° to 90°.

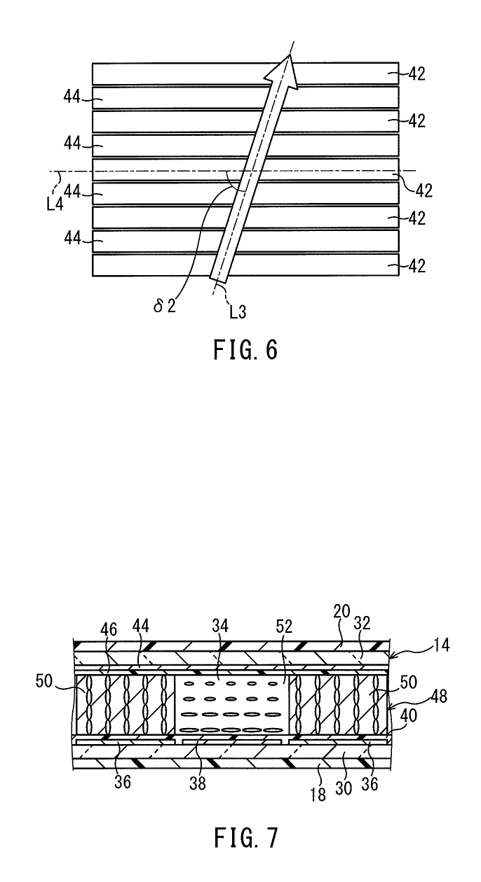

The other substrate 32 is, for example, a low-alkali glass substrate. On the substrate 32, drive electrodes 42 and auxiliary electrodes 44 are arrayed alternately, as shown in FIG. 6. Each of the electrodes 42 and 44 is, for example, a transparent conductive film such as an indium tin oxide film (ITO film).

The drive electrodes 42 and the auxiliary electrodes 44 extend in the lateral direction of the substrate 32 (in the lateral direction of the display area of the display panel 12), in an approximately uniform width each. In other words, the drive electrodes 42 and the auxiliary electrodes 44 are alternately arrayed in the longitudinal direction of the substrate 32 (in the longitudinal direction of the display area of the display panel 12).

The drive electrodes 42 and the auxiliary electrodes 44 are covered with an alignment film 46. The alignment film 46 is, for example, a polyimide resin film. As shown in FIG. 6, an angle δ2 formed between a rubbing axis L3 of the alignment film 46 and a reference line L4, which extends in the lateral direction of the substrate 32, is set in, for example, a range of 35° to 90°. In the liquid crystal in the TN mode, the angle δ2 is set to be the same as the angle δ1.

The liquid crystal layer 34 is sealed between the pair of substrates 30 and 32. In the switching liquid crystal panel 14, the operation mode of the liquid crystal is the TN mode.

The retardation (Δn·d) of the liquid crystal layer 34 is set at, for example, a first minimum. Here, Δn represents a refractive index anisotropy, which is indicative of a difference between a refractive index along the long axis of the liquid crystal molecule and a refractive index along the short axis thereof. Further, d represents a thickness of the liquid crystal layer 34, which is indicative of a cell gap.

The dielectric anisotropy Δε of the liquid crystal layer 34 is set at, for example, 4 or greater. Here, Δε represents a difference between a dielectric constant along the long axis of the liquid crystal molecule and a dielectric constant along the short axis thereof.

In the stereoscopic display device 10, a parallax barrier is realized in the switching liquid crystal panel 14. The following explains the parallax barrier 48 while referring to FIG. 7. In order to realize the parallax barrier 48, the auxiliary electrodes 38, the drive electrodes 42, and the auxiliary electrodes 44 (see FIG. 6) are caused to have the same potential (for example, 0 V), and the drive electrodes 36 are caused to have a different potential from that of these electrodes 38, 42, and 44 (for example, 5 V). This causes the orientations of the liquid crystal molecules present between the drive electrodes 36 and the counter electrode (the drive electrodes 42 and the auxiliary electrodes 44) to change. In the liquid crystal layer 34, therefore, parts that are positioned between the drive electrodes 36 and the counter electrode (the drive electrodes 42 and the auxiliary electrodes 44) function as light shielding parts 50, and each part positioned between adjacent two of the light shielding parts 50 functions as a transmission part 52. As a result, the parallax barrier 48 is realized in which the light shielding parts 50 and the transmission parts 52 are arrayed alternately. The direction in which the light shielding parts 50 and the transmission parts 52 are arrayed alternately is the lateral direction of the display area of the display panel 12.

The method of applying voltages to the electrodes 36, 38, 42, and 44, respectively, in order to realize the parallax barrier 48 in the switching liquid crystal panel 14 may be, for example, a method in which a voltage applied to the drive electrodes 36 and a voltage applied to the other electrodes 38, 42, and 44 have opposite phases to each other, or a method in which a voltage is applied to the drive electrodes 36 while the other electrodes 38, 42, and 44 are grounded. The voltage to be applied is, for example, a voltage of 5 V in a rectangular waveform.

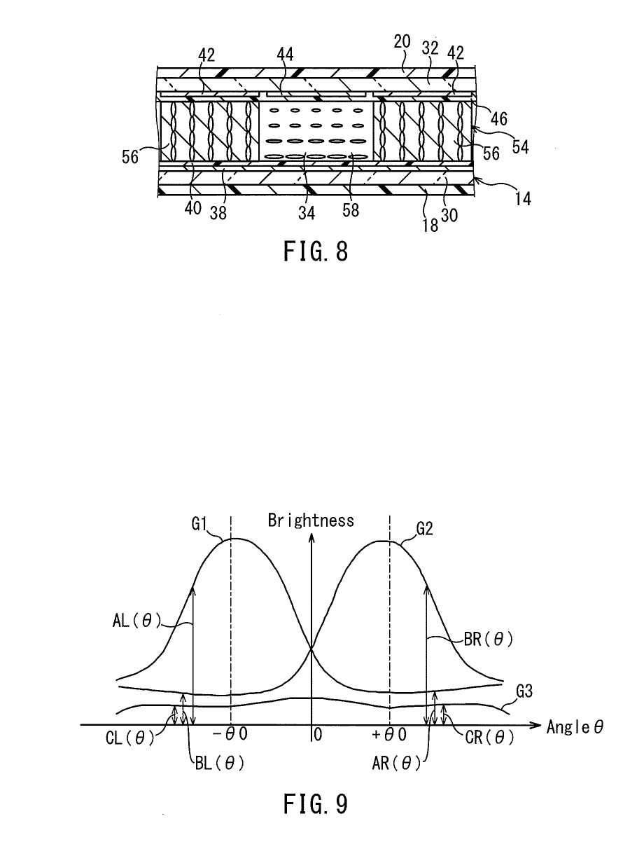

Alternatively, in the stereoscopic display device 10, a parallax barrier 54 may be realized in the switching liquid crystal panel 14, other than the parallax barrier 48. The following explains the parallax barrier 54 while referring to FIG. 8. In order to realize a parallax barrier 54, the drive electrodes 36 (see FIG. 5), the auxiliary electrodes 38, and the auxiliary electrodes 44 are caused to have the same potential (for example, 0 V), and the drive electrodes 42 are caused to have a different potential from that of these electrodes 36, 38, and 44 (for example, 5 V). This causes the orientations of the liquid crystal molecules present between the drive electrodes 42 and the counter electrode (the drive electrodes 36 and the auxiliary electrodes 38) to change. In the liquid crystal layer 34, therefore, parts that are positioned between the drive electrodes 42 and the counter electrode (the drive electrodes 36 and the auxiliary electrodes 38) function as light shielding parts 56, and each part positioned between adjacent two of the light shielding parts 56 functions as a transmission part 58. As a result, the parallax barrier 54 is realized in which the light shielding parts 56 and the transmission parts 58 are arrayed alternately. The direction in which the light shielding parts 56 and the transmission parts 58 are arrayed alternately is the longitudinal direction of the display area of the display panel 12.

The method of applying voltages to the electrodes 36, 38, 42, and 44, respectively, in order to realize the parallax barrier 54 in the switching liquid crystal panel 14 may be, for example, a method in which a voltage applied to the drive electrodes 42 and a voltage applied to the other electrodes 36, 38, and 44 have opposite phases to each other, or a method in which a voltage is applied to the drive electrodes 42 while the other electrodes 36, 38, and 44 are grounded. The voltage to be applied is, for example, a voltage of 5 V in a rectangular waveform.

In the stereoscopic display device 10, a synthetic image obtained by alternately arraying the portions of the right eye image and the portions of the left eye image obtained by dividing into a stripe form each is displayed in the display area of the display panel 12, in a state in which the parallax barrier is realized in the switching liquid crystal panel 14. This allows only the right eye image to reach the right eye of a viewer, and allows only the left eye image to reach the left eye of the viewer. As a result, the viewer can view a stereoscopic image without using special glasses.

In the stereoscopic display device 10, a planar image may be displayed on the display panel 12 in a state in which the parallax barrier is not realized in the switching liquid crystal panel 14, so that the planar image can be shown to the viewer.

With regard to the stereoscopic display device 10 of the present embodiment, an experiment for examining the relationship between the dielectric anisotropy Δε of liquid crystal and the crosstalk ratio was carried out (Experiment 1). Here, the crosstalk ratio indicates to what extent the level of black display increases with respect to background components (both are displayed in black), for example, when either the pixels 28 for the left eye image or the pixels 28 for the right eye image are caused to perform white display and the others are caused to perform black display in a state where the parallax barrier 48 is realize in the switching liquid crystal panel 14. This is an index that shows to what extent either the right eye image or the left eye image is viewed on the other.

The crosstalk ratio is explained below in more detail, with reference to FIG. 9. FIG. 9 shows a graph that shows the relationship between an angle θ and brightness. The angle θ is, for example, an angle of inclination to left or right with respect to a position of viewing the display panel 12 straightly in front of the same. In FIG. 9, the graph G1 shows the relationship between the brightness and the angle θ in a state in which a right eye image is displayed in black and a left eye image is displayed in white. The graph G2 shows the relationship between the brightness and the angle θ in a state in which a right eye image is displayed in white and a left eye image is displayed in black. The graph G3 shows the relationship between the brightness and the angle θ in a state in which a right eye image and a left eye image are displayed in black. A naked eye stereoscopic display device has a position (eye point) optimal for viewing a stereoscopic display. Though the angle varies with a designed visibility distance, the eye point of the left eye is at such a position that the brightness is maximum in the graph G1, and the angle herein is −θ0. The eye point of the right eye is at such a position that the brightness is maximum in the graph G2, and the angle herein is +θ0.

Here, the crosstalk ratio is defined according to the formulae (1) and (2) shown below:

LXT={(BL(θ)−CL(θ))/(AL(θ)−CL(θ))}*100 (1)

RXT={(AR(θ)−CR(θ))/(BR(θ)−CR(θ))}*100 (2)

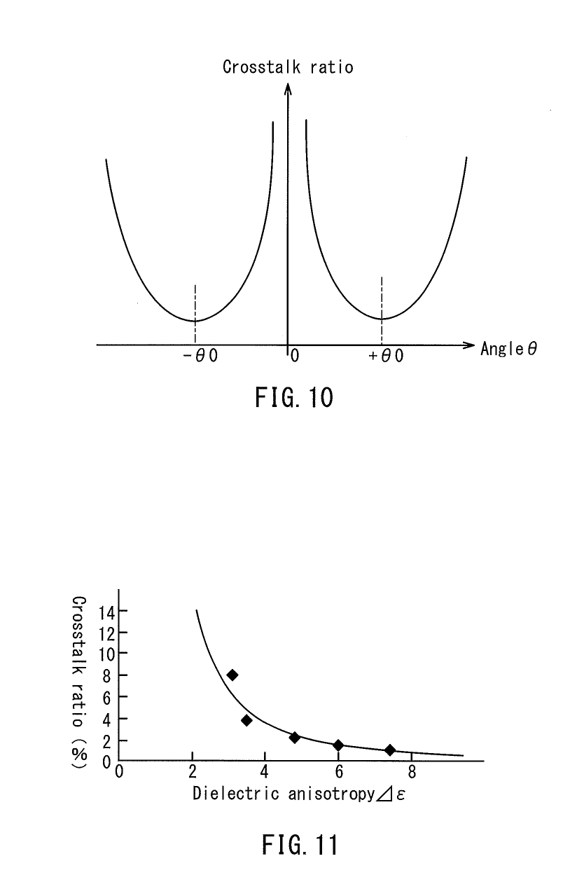

In the formulae, LXT represents a crosstalk ratio for the left eye; RXT represents a crosstalk ratio for the right eye; and θ represents the above-described angle θ. As shown in FIG. 9, AL(θ) represents a brightness of an image viewed by the left eye in the graph G1, AR(θ) represents a brightness of an image viewed by the right eye in the graph G1, BL(θ) represents a brightness of an image viewed by the left eye in the graph G2, BR(θ) represents a brightness of an image viewed by the right eye in the graph G2, CL(θ) represents a brightness of an image viewed by the left eye in the graph G3, and CR(θ) represents a brightness of an image viewed by the right eye in the graph G3. The crosstalk ratio determined by the above-described formulae (1) and (2) becomes minimum at the eye points (angle θ=+θ0 and θ=−θ0), as shown in FIG. 10. Hereinafter, the crosstalk ratio refers to a crosstalk ratio at the eye points. Generally, as the crosstalk ratio is lower, more excellent 3D display can be obtained, and influences to human bodies can be reduced.

In Experiment 1, the transmission part 52 had an opening width of 70 μm. The light shielding part 50 had a width of 126 μm. The clearance between the drive electrode 36 and the auxiliary electrode 38 was 6 μm. The transmission part 56 had an opening width of 92 μm. The light shielding part 58 had a width of 104 μm. The clearance between the drive electrode 42 and the auxiliary electrode 44 was 6 μm. The pixel pitch was 104 μm. The liquid crystal had Δn of 0.078. It should be noted that Δn of the liquid crystal was set at a first minimum in the case where the liquid crystal layer 34 had a thickness of 6.5 μm. δ1 shown in FIG. 5 and δ2 shown in FIG. 6 were 27°.

The results of Experiment 1 are shown in FIG. 11. Here, the crosstalk ratios shown in FIG. 11 indicate crosstalk ratios at the eye points. In Experiment 1, the eye points were at the positions of approximately +6° and −6°.

Experiment 1 proves, as is clear from FIG. 11, that the dielectric anisotropy of the liquid crystal and the crosstalk ratio correlate with each other. By setting the retardation of the liquid crystal at a first minimum and setting the dielectric anisotropy Δε of the liquid crystal at 4 or greater, the crosstalk ratio can be reduced to less than 4%. It can be considered that this results from that light leakage in the inter-line areas is reduced and the light shielding properties of the light shielding parts improve.

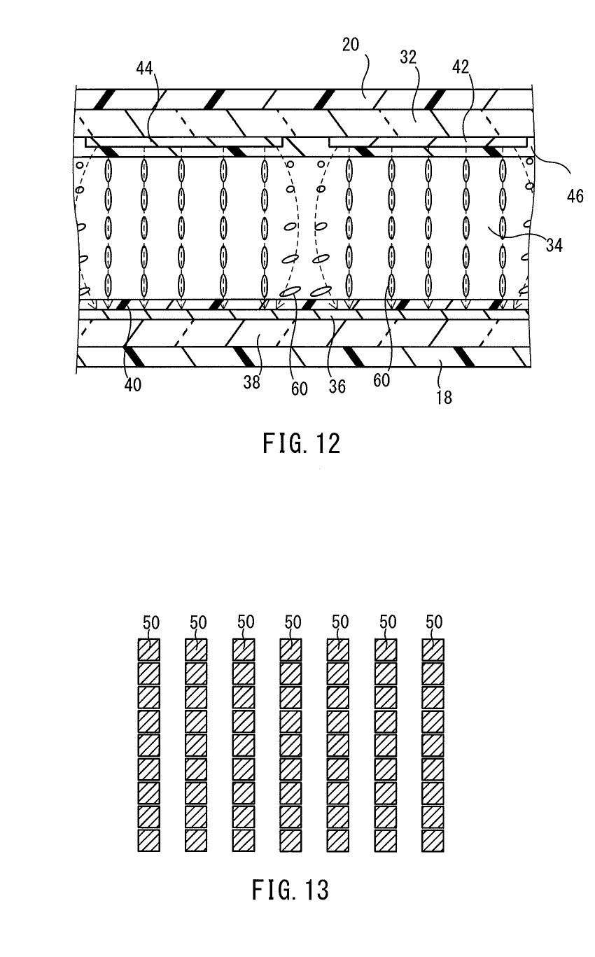

Here, the reason why light leakage in the light shielding parts is reduced when the retardation Δn·d of the liquid crystal is set at a first minimum and the dielectric anisotropy Δε of the liquid crystal is 4 or greater (hereinafter referred to as preferable conditions) is explained with reference to FIGS. 12 to 15. FIGS. 12 to 15 show the case of the light shielding parts 50 as an example, but the same concept applies to the case of light shielding parts 56.

In the case where the liquid crystal does not satisfy the preferable conditions, it is not likely that liquid crystal molecules 60 in the inter-line areas between the drive electrodes 42 and the auxiliary electrodes 44 in the liquid crystal layer 34 would be influenced by an electric field. Therefore, as shown in FIG. 12, the orientation of the liquid crystal molecules 60 is far from the orientation of the liquid crystal molecules 60 positioned between the drive electrodes 42 or the auxiliary electrodes 44 and the drive electrodes 36. As a result, light leakage occurs in the inter-line areas in the light shielding parts 50. FIG. 13 is a model diagram showing the light shielding parts 50 in this state. It should be noted that, to facilitate understanding, FIG. 13 shows a state in which the light shielding parts 50 are segmentalized in the lengthwise direction, but these segmentalizing parts (inter-line areas) have poorer light shielding properties as compared with the other parts in fact. As a result, light leaks.

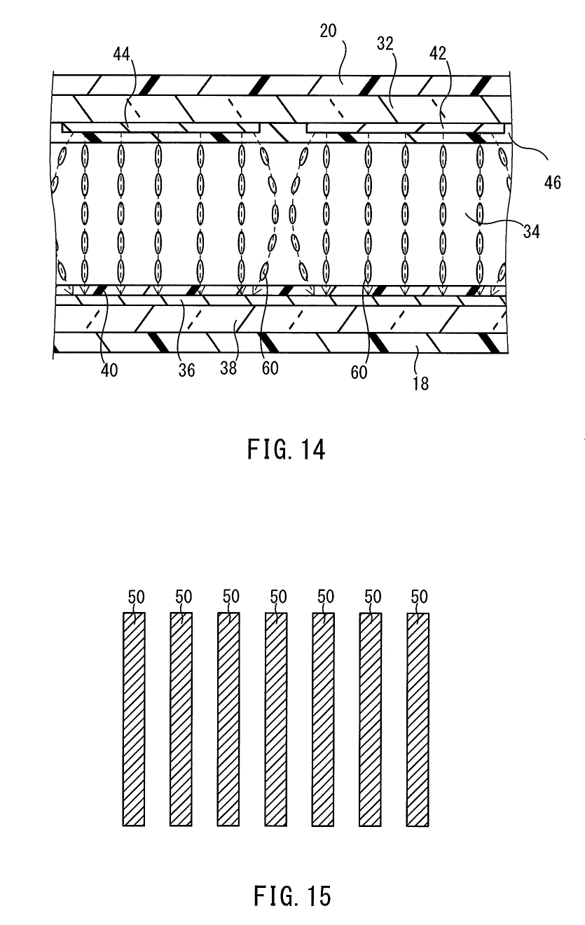

On the other hand, in the case where the liquid crystal satisfies the preferable conditions, the liquid crystal molecules 60 in parts corresponding to the areas between the drive electrodes 42 and the auxiliary electrodes 44 in the liquid crystal layer 34 are easily influenced by an electric field. Therefore, as shown in FIG. 14, the orientation of the liquid crystal molecules 60 is close to the orientation of liquid crystal molecules 60 positioned between the drive electrodes 42 or the auxiliary electrodes 44 and the drive electrodes 36. This makes it possible to expand light blocking areas (barriers), also in parts corresponding to the areas (inter-line parts) between the drive electrodes 42 and the auxiliary electrodes 44 in the light shielding parts 50, whereby the function of light shielding part 50 to block light can be ensured sufficiently. As a result, it is possible to prevent the crosstalk ratio from deteriorating. FIG. 15 is a model diagram showing the light shielding parts 50 in this state. It should be noted that, to facilitate understanding, FIG. 15 shows a state in which there are no segmentalization areas as shown in FIG. 13, but it is not necessary that the segmentalization areas as shown in FIG. 13 should be eliminated completely.

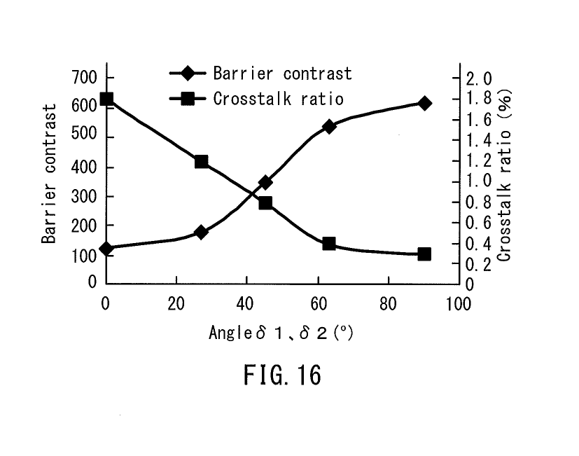

An experiment (Experiment 2) for examining the relationship between the rubbing directions of the alignment films 40 and 46 and the crosstalk ratio was performed, in order to further reduce the crosstalk ratio in the stereoscopic display device 10 of the present embodiment. The experiment conditions of Experiment 2 were the same as those of Experiment 1, except for the rubbing directions of the alignment films 40 and 46. The results of Experiment 2 are shown in FIG. 16.

Further, an experiment (Experiment 3) for examining the relationship between the rubbing directions of the alignment films 40 and 46 and the barrier contrast was performed. The barrier contrast was measured in the following manner: to evaluate light shielding properties, the switching liquid crystal panel 14 provided with the polarizing plates 18 and 20 was located on a backlight (not shown), and a transmittance when a pseudo full-screen black display was provided by applying a voltage to the drive electrodes 36 and the auxiliary electrodes 38, and a transmittance when a full-screen white display was provided by applying no voltage to the drive electrodes 36 and the auxiliary electrodes 38, were compared. The other experiment conditions were the same as those of Experiment 1. The results of Experiment 3 are shown together in FIG. 16.

As shown in FIG. 16, the rubbing directions of the alignment films and the barrier contrast correlate with each other, and as δ1 and δ2 increase, the barrier contrast increases, and the light shielding properties improve. Further, in the case where δ1 shown in FIG. 5 and δ2 shown in FIG. 6 are both 35° or greater, the crosstalk ratio is smaller than 1%. This results from the following: as δ1 and δ2 are closer to 90°, the rubbing state in the inter-line areas (the areas where steps caused by the transparent electrodes are present) becomes more unsatisfactory, thereby making the liquid crystal molecules more unstable and hence more responsive even to a lower electric field. As a result, the light shielding properties of the inter-line areas improve, whereby the crosstalk ratio is reduced.

So far an embodiment of the present invention has been described in detail, but it is merely an example and does not limit the present invention at all.

For example, in the foregoing embodiment, the display panel 12 may be a plasma display panel, an organic EL (Electro Luminescence) panel, an inorganic EL panel, or the like.

Further, in the foregoing embodiment, the other substrate 32 may be arranged on the display panel 12 side.

1. A stereoscopic display device comprising:
a display panel that has a plurality of pixels, and displays a synthetic image in which a right eye image and a left eye image that are divided in a stripe form are arrayed alternately; and
a switching liquid crystal panel that is arranged on one side in the thickness direction of the display panel and is capable of realizing a parallax barrier in which transmission parts that transmit light and light shielding parts that block light are arranged alternately,
wherein the switching liquid crystal panel includes:
a pair of substrates;
a liquid crystal layer sealed between the substrates in pair;
a plurality of drive electrodes formed on each of the substrates in pair; and
a plurality of auxiliary electrodes formed on each of the substrates in pair, the auxiliary electrodes and the drive electrodes being arranged alternately,
the drive electrodes and the auxiliary electrodes formed on one of the substrates in pair are orthogonal to the drive electrodes and the auxiliary electrodes formed on the other substrate when viewed from the front of the switching liquid crystal panel,
a voltage different from a voltage applied to the drive electrodes and the auxiliary electrodes formed on the one substrate is applied to the drive electrodes formed on the other substrate, whereby the light shielding parts are formed,
the liquid crystal layer has a retardation set at a first minimum, and
the liquid crystal layer has a dielectric anisotropy of 4 or greater.

2. The stereoscopic display device according to claim 1,
wherein each of the substrates in pair includes an alignment film, and
an angle formed between an alignment axis of the alignment film and a reference line that extends in a lengthwise direction of the drive electrodes is 35° or greater.
